(19) United States
(12) Patent Application Publication
(10) Pub. No.: US 2010/0258395 A1
(43) Pub. Date: Oct. 14, 2010

(54) BRAKING DEVICE, IN PARTICULAR FOR ROLLING CURTAINS, SHUTTERS, MOSQUITO NETS AND THE LIKE

(75) Inventor: Giuseppe Busi, Bergamo (IT)

Correspondence Address: KING & SCHICKLI, PLLC, 247 NORTH BROADWAY, LEXINGTON, KY, 40507, US

(73) Assignee: TECNOST s.n.c. Di Busi Giuseppe & C.

(21) Appl. No.: 12/747,319

(22) PCT Filed: Dec. 9, 2008
(86) PCT No.: PCT/EP08/67147

§ 371 Date: Jun. 10, 2010

(30) Foreign Application Priority Data
Dec. 11, 2007 (IT) BG2007A000057

(51) Int. Cl. F16F 9/14

(52) U.S. Cl. 188/306

(57) ABSTRACT

Braking device comprising a rotor (3; 13) suitable for rotating around a main axis (X) in a substantially cylindrical seat (9; 19) suitable for containing a viscous fluid, wherein said seat (9; 19) is offset with respect to the main axis (X) and the rotor (3; 13) is provided with at least one rocking vane (4; 14) which is arranged substantially parallel to the main axis (X) for translating with an alternating motion with respect to the rotor (3; 13).

The present invention relates to a braking device, in particular a braking device which can be used for slowing down the rolling speed of rolling curtains, shutters, mosquito nets and the like.

Several devices are known for slowing down the rolling speed of mobile curtains, shutters, mosquito nets and the like.

Generally, said known devices comprise an outer case, prevalently cylindrical-shaped, in which a cylindrical-shaped coaxial seat is made. This seat contains a rotor, generally consisting of a cylindrical-shaped pin, provided with fixed vanes which extend in a radial direction on the circumference. One end of said pin is immersed in a fluid with varying density contained in the coaxial seat of the case, such as oil, grease or the like, and the other end is connected to the main shaft, where the mobile curtains are rolled, through a generally unidirectional rotating device.

Said pin, being immersed in a fluid, meets a force opposing the rotation force generally generated by the spring, so as to obtain a rolling with a controlled speed, while during the unrolling phase of the curtain the unidirectional rotating device allows the free unrolling of the main shaft on which the mobile curtains are rolled.

Said devices have a similar working, since they all have generally a rotor pin provided with fixed vanes immersed in a fluid, while there are some differences in the unidirectional rotating device. Some manufacturers use a helical spring system having an end integral with the rotor pin and the other end integral with the main rolling shaft of the mobile curtain. Said spring, rotated in the rotation direction of its own coiling, tightens around the rotor pin, thus generating a sufficient transmission torque for rotating the rotor pin, so that the latter undergoes a slowdown thanks to the fluid contained in the case, which opposes a determinate resistance to the vanes which are rotated.

Other manufacturers obtain instead the unidirectional rotation transmission by using other systems, for example by providing an end of the rotor pin with elastic oriented teeth, which engage with corresponding teeth made on the main rolling shaft of the mobile curtain.

Said teeth have on one side of their surface a face perpendicular to the corresponding teeth arranged on the driven member, so as to transmit the motion with clearly limited torques, while on the surface opposite to the perpendicular face they have an inclined plane, so as to allow, in case of an inversion of the rotating direction, a slipping of the driven member.

These known devices have however some disadvantages, since the efficacy of the braking system may change according to the temperature of use of the device. As a matter of fact, the fluids generally change their density according to the working temperature and a curtain generally arranged outside a house remarkably suffers the thermal ranges, quantifiable in some tenths of degrees, depending on whether it is used in summer or in winter.

Another disadvantage can further happen because of the system used for the motion transmission, especially when this system is carried out through elastic teeth which engage with each other in a rotation direction while in the other direction they mutually slip on the surfaces. As a matter of fact, surfaces working with a mutual friction are subject to wear, thereby compromising the reliability of the system during the time.

It is therefore an object of the present invention to provide a braking device for rolling curtains, generally for rolling shutters, mosquito nets and the like, which is more effective and reliable of the generally used systems, and which is however easy and economic to manufacture.

Another object of the invention is to provide a device which does not suffer the thermal ranges which occur during the different seasons.

A further object of the invention is to provide a unidirectional rotating device which has a good reliability and duration during the time.

A further object of the invention is to provide a device which can be manufactured at lower costs.

Said objects are achieved with a braking device, whose main features are disclosed in the first claim, while other features are disclosed in the remaining claims.

In particular, these and other objects which will be clear later on are obtained by a braking devices for slowing down the rolling speed on mobile curtains with spring rolling such as rolling shutters, mosquito nets and the like, which comprises a cylindrical-shaped case, in which a cylindrical-shaped hole is made, which develops along the main axis of the case, having the function of housing the rotor pin, and provided with a seat offset with respect to the main axis of the hole, said seat having the function of containing a certain quantity of viscous fluid (oil, grease or the like) kept in place through a suitable gasket and of guiding a rocking vane, inserted in a suitable seat made on the rotor pin and arranged substantially parallel to the main axis of the rotor pin, wherein said seat, made on the rotor pin with a slightly greater size with respect to the section size of the rocking vane, allows its perpendicular translation with respect to the main axis.

In a first embodiment, the rotor pin engages at the end arranged toward the curtain-rolling tube in a rotatable ring, said ring having on its surface perpendicular to the development axis of said ring, at least one seat having the function of containing at least one peg, wherein said seat is shaped eccentrically with respect to the main axis of the ring, which has the function of moving the peg away or close to the radial surface of the rotor pin, according to the clockwise or anticlockwise direction of rotation of the rotor pin, so as to generate an idle transmission of the curtain-rolling tube while moving away or a dragged transmission while moving close.

In a second embodiment, the ring has a series of rigid teeth on its surface radial to the development axis, wherein the rotor pin has also specular teeth. According to the orientation of the teeth, the curtain-rolling tube transmits the rotating motion to the rotor pin in the desired direction. Thanks to these rigid teeth with a good thickness and to the wear-resistant material which is used, the system has the best guarantees of working and duration during the use which it is subject to. The mobility of the ring for having the engagement with the rotor pin is given by a spring kept in place by a seeger ring.

Further advantages and features of the braking device according to the present invention will become clear to those skilled in the art from the following detailed and non-limiting description of two embodiments thereof with reference to the attached drawings, wherein:

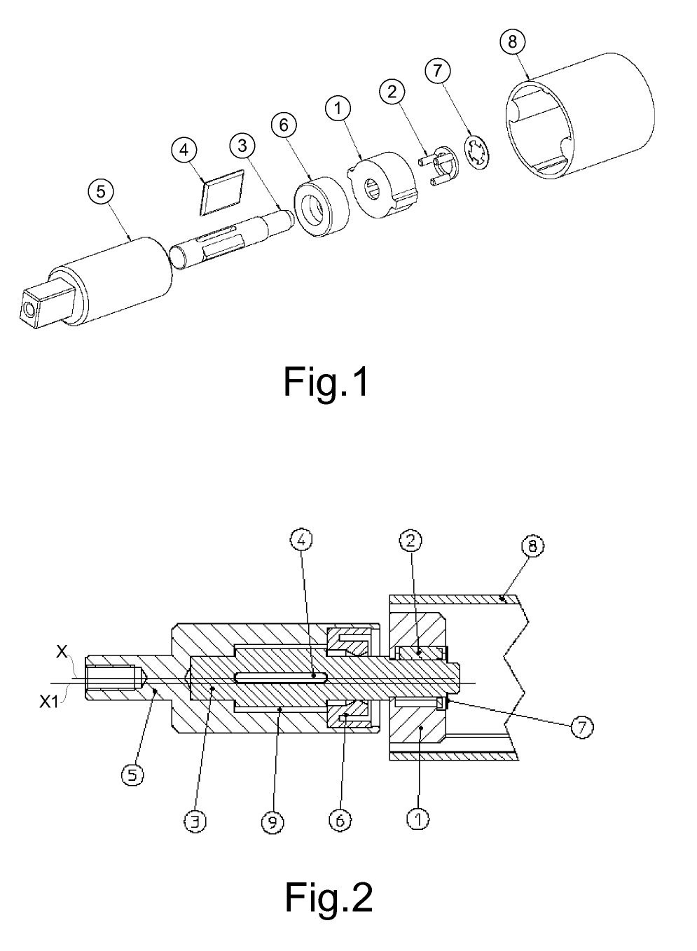

FIG. 1 shows an exploded perspective view of the first embodiment of the device;

FIG. 2 shows an enlarged longitudinal section of the device of FIG. 1;

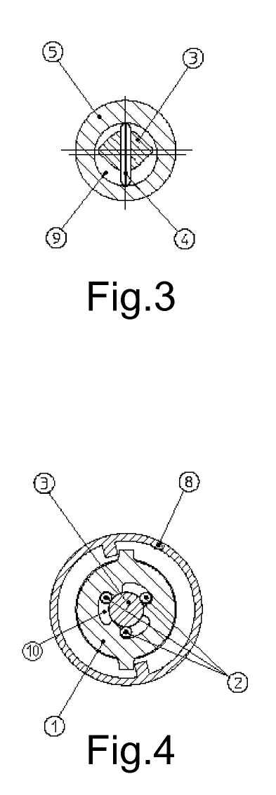

FIG. 3 shows a first enlarged cross-section of the device of FIG. 1;

FIG. 4 shows a second enlarged cross-section of the device of FIG. 1;

FIG. 5 shows an exploded perspective view of the second embodiment of the device;

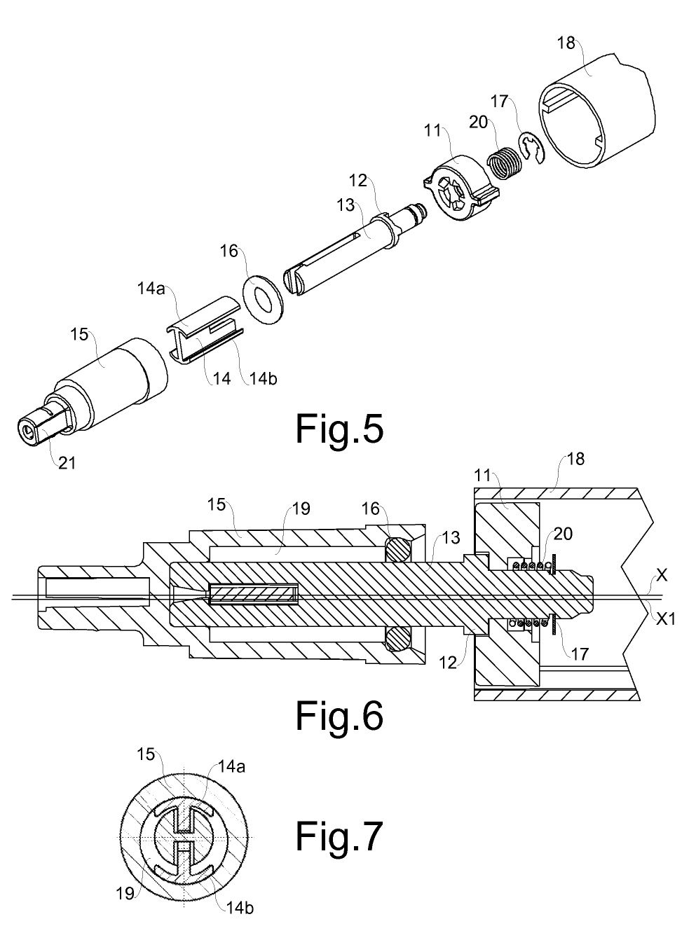

FIG. 6 shows an enlarged longitudinal section of the device of FIG. 5; and

FIG. 7 shows an enlarged cross-section of the device of FIG. 5.

Referring to FIGS. 1 to 4, it is seen that the braking device according to the first embodiment of the present invention comprises in a known way a cylindrical-shaped case 5 provided with a substantially cylindrical hub arranged in a substantially coaxial manner along main axis X, which in particular coincides with the longitudinal axis, of case 5 for housing a rotor pin 3. Case 5 is provided also with a substantially cylindrical-shaped seat 9, which is offset with respect to main axis X and is suitable for containing a certain amount of a viscous fluid, for example oil, grease or the like, contained through a suitable gasket 6.

According to the invention, seat 9 is also suitable for guiding a rocking vane 4 inserted in a suitable seat, in particular a slit, made on rotor pin 3 and arranged substantially parallel to main axis X of rotor pin 3. The seat of rocking vane 4 is made on rotor pin 3 with a slightly increased size with respect to the size of the cross-section of rocking vane 4, so that the latter can translate with an alternating motion along a direction substantially perpendicular to main axis X.

An end of rotor pin 3 is turned toward a tube 8, in particular a curtain-rolling tube, and is engaged in a rotating ring 1 which has at least one seat 10 having the function of containing at least one mobile peg 2, said seat 10 being shaped eccentrically with respect to the main axis of ring 1 and having the function of moving mobile peg 2 away from or close to the radial surface of rotor pin 3, according to the clockwise or anticlockwise direction of rotation of rotor pin 3, so as to generate an idle transmission of rotor pin 3 with respect to the direction of rotation of tube 8 during the moving-away phase of mobile peg 2 with respect to the radial surface of rotor pin 3, or to generate a dragged rotation of rotor pin 3 in the rotation direction of tube 8, during the moving-close phase of mobile peg 2 with respect to the radial surface of rotor pin 3. The first embodiment of the device comprises three mobile pegs 2 connected to each other by a ring and kept in three seats 10 of ring 1 by means of a stop ring 7.

Rotor pin 3, during the rotation phase dragged by tube 8, rotates with respect to its own main axis X rocking vane 4, which, by rotating inside seat 9, moves a certain amount of a viscous fluid from the chamber having a bigger volume resulting between rocking vane 4 and the inside of offset seat 9 toward the chamber having a smaller volume which is created between rocking vane 4 and the inside of offset seat 9 due to the rotation of rotor pin 3 around main axis X, with respect to seat 9 centered on a secondary axis X1 substantially parallel to main axis X.

Said viscous fluid, by passing from the chamber with a bigger volume to the chamber with the smaller volume of seat 9, undergoes a compression, and it is therefore compelled to pass through narrowings obtained from the coupling clearance of rocking vane 4 inside offset seat 9, thereby braking the rotation of rotor pin 3.

Referring to FIGS. 5 to 7, it is seen that the second embodiment of the braking device is similar to the first embodiment, since it comprises a cylindrical-shaped case 15 provided with a hub which houses a rotor pin 13 for rotating around a main axis X. Case 15 is also provided with a substantially cylindrical-shaped seat 19, which is offset with respect to main axis X and is suitable for containing a certain amount of a viscous fluid, for example oil, grease or the like, contained through a suitable gasket 16.

Seat 19 is also suitable for guiding a rocking vane 14 inserted in a slit made on rotor pin 13 and arranged substantially parallel to main axis X of rotor pin 13, so that rocking vane 14 can translate with an alternating motion along a direction substantially perpendicular to main axis X. One or two edges of rocking vane 14 are provided with curved fins 14a and/or 14b suitable for sliding along the inner surface of seat 19 for increasing the friction surface. The curvature radius of fins 14a, 14b is substantially equal to the curvature radius of the inner surface of seat 19.

An end of rotor pin 13 is turned toward a tube 18, in particular a curtain-rolling tube, and is engaged in a rotating ring 11. Rotor pin 13 is provided with one or more radial teeth 12 suitable for engaging with complementary teeth protruding from the inside of ring 11. The orientation of radial teeth 12 characterizes the direction of rotation of the device: by rotating in one direction the teeth of ring 11 engage with radial teeth 12 of rotor pin 13, so as to rotate it, while in the opposite direction the inclined surface of the teeth allows ring 11 to freely rotate. Ring 11 and radial teeth 12 stay in contact thanks to the thrust of a helical spring 20 arranged around rotor pin 13 and kept in position by a seeger ring 17. Case 15 is provided with a fast connection 21 for allowing an easy and fast insertion thereof.

Possible modifications and/or additions may be made by those skilled in the art to the hereinabove disclosed and illustrated embodiments while remaining within the scope of the following claims.

1. Braking device comprising a rotor (3; 13) suitable for rotating around a main axis (X) in a substantially cylindrical seat (9; 19) suitable for containing a viscous fluid, characterized in that said seat (9; 19) is offset with respect to the main axis (X) and the rotor (3; 13) is provided with at least one rocking vane (4; 14) which is arranged substantially parallel to the main axis (X) for translating with an alternating motion with respect to the rotor (3; 13).

2. Braking device according to claim 1, characterized in that the rocking vane (4; 14) is guided by the inner surface of the seat (9; 19).

3. Braking device according to claim 1, characterized in that the seat (9; 19) is offset on a secondary axis (XI) substantially parallel to the main axis (X).

4. Braking device according to claim 1, characterized in that the rocking vane (4; 14) translates along a direction substantially perpendicular to the main axis (X).

5. Braking device according to claim 1, characterized in that the rotor (3; 13) is engaged in a ring (1; 11) so as to rotate with it in one direction only.

6. Braking device according to claim 5, characterized in that the ring (1) has at least one seat (10) for containing at least one mobile peg (2), said seat (10) being shaped eccentrically with respect to the main axis of the ring (1) for moving the mobile peg (2) away from or close to the radial surface of the rotor (3), according to the direction of rotation of the rotor (3).

7. Braking device according to claim 5, characterized in that the rotor (13) is provided with one or more radial teeth (12) suitable for engaging in one direction only with teeth protruding inside the ring (11).

8. Braking device according to claim 7, characterized in that the ring (11) and the radial teeth (12) stay in contact thanks to the thrust of a helical spring (20) arranged around the rotor (13).

9. Braking device according to one of the previous claims, characterized in that the rotor (3; 13) is a pin.

10. Braking device according to claim 1, characterized in that the rocking vane (4; 14) is inserted in a seat, in particular a slit, made on the rotor (3; 13).

11. Braking device according to claim 1, characterized in that one or two edges of the rocking vane (14) are provided with curved fins (14a, 14b) suitable for sliding along the inner surface of the seat (9; 19).

12. Braking device according to claim 11, characterized in that the curvature radius of the tins (14a, 14b) is substantially equal to the curvature radius of the inner surface of the seat (19).

13. Braking device according to claim 2, characterized in that the seat (9; 19) is offset on a secondary axis (X1) substantially parallel to the main axis (X).

14. Braking device according to claim 2, characterized in that the rocking vane (4; 14) translates along a direction substantially perpendicular to the main axis (X).

15. Braking device according to claim 3, characterized in that the rocking vane (4; 14) translates along a direction substantially perpendicular to the main axis (X).

16. Braking device according to claim 2, characterized in that the rotor (3; 13) is engaged in a ring (1; 11) so as to rotate with it in one direction only

17. Braking device according to claim 3, characterized in that the rotor (3; 13) is engaged in a ring (1; 11) so as to rotate with it in one direction only

18. Braking device according to claim 4, characterized in that the rotor (3; 13) is engaged in a ring (1; 11) so as to rotate with it in one direction only

19. Braking device according to claim 5, characterized in that the rocking vane (4; 14) is inserted in a seat, in particular a slit, made on the rotor (3; 13).

20. Braking device according to claim 5, characterized in that one or two edges of the rocking vane (14) are provided with curved fins (14a, 14b) suitable for sliding along the inner surface of the seat (9; 19).
